(19) United States
(12) Patent Application Publication
(10) Pub. No.: US 2013/0061894 A1
(43) Pub. Date: Mar. 14, 2013

(54) Ferrule for Ambulatory Aids

(71) Applicant: Stephen Liu, Dallas, TX (US)

(72) Inventor: Stephen Liu, Dallas, TX (US)

(21) Appl. No.: 13/230,565

(22) Filed: Sep. 12, 2011

(51) Int. Cl. A61H 3/00; A45B 9/04

(52) U.S. Cl. 135/82; 16/42 T; 135/77; 135/86

(57) ABSTRACT

A ferrule is disclosed which includes a housing having an aperture at a first end which is adapted to receive a leg of an ambulatory aid. The ferrule includes a gliding component having a gliding surface at a second end of the housing. The gliding surface is adapted to slidably engage a floor surface. The ferrule also includes a traction component located at the second end of the housing. The traction component selectively engages the floor surface with a traction surface.

### BACKGROUND OF THE INVENTION

1. Field

The present invention is related generally to ambulatory aids. More particularly, the present invention is directed to an improved ferrule adapted for use on the end of one or more legs of an ambulatory aid.

2. Background

An ambulatory aid is a device for assisting users who may have difficulty standing or walking. Some users may utilize an ambulatory aid due to a physiological abnormality, an injury, or advanced age. For example, a significant portion of the population, often referred to as “the baby boomer generation,” is reaching an age where unassisted mobility is becoming increasingly difficult. With advanced age, an elderly person may suffer from the loss of equilibrium and become unsteady while standing or walking. In addition, the elderly may experience weakened muscles and stiff joints that make walking difficult or painful. Consequently, a user of an ambulatory aid may rely upon the ambulatory aid to help maintain their balance and support their weight.

The two most prevalent types of ambulatory aids are walkers and canes. Both walkers and canes are often fitted with some form of terminal accessory, such as wheels or ferrules. A ferrule is a cap, typically constructed from plastic or rubber, which is affixed to the end of a cane or to one or more legs of a walker and contacts a floor surface on which a user traverses.

### SUMMARY

An illustrative embodiment provides for a ferrule. The ferrule includes a housing having an aperture at a first end which is adapted to receive a leg of an ambulatory aid. The ferrule also includes a gliding component having a gliding surface at a second end of the housing. The gliding surface is adapted to slidably engage a floor surface. Additionally, the ferrule includes a traction component at the second end of the housing. The traction component selectively engages the floor surface with a traction surface.

Another illustrative embodiment provides for an ambulatory aid. The ambulatory aid includes a set of ferrules coupled to the ambulatory aid. Each ferrule in the set of ferrules has a housing with an aperture at a first end. The aperture is adapted to accept a leg of the ambulatory aid. Each ferrule also includes a gliding component having a gliding surface at a second end of the housing. The gliding component slidably engages a floor surface. Additionally, each ferrule in the set of ferrules includes a traction component at the second end of the housing. The traction component selectively engages the floor surface with a traction surface.

Still another illustrative embodiment provides for a method of operating a ferrule coupled to a leg of an ambulatory aid. In response to a compressing force, a gliding component of the ferrule retracts into a cavity within a housing of the ferrule. A traction surface of a traction component of the ferrule engages a floor surface. And, in response to a release of the compressing force, at least a portion of the gliding component is ejected from the cavity and the traction surface is disengaged from the floor surface.

### BRIEF DESCRIPTION OF THE DRAWINGS

The novel features believed characteristic of the invention are set forth in the appended claims. The illustrative embodiments, as well as a preferred mode of use, further objectives and advantages thereof, will best be understood by reference to the following detailed description when read in conjunction with the accompanying drawings, wherein like reference numerals represent like parts, in which:

FIG. 1 is an illustration of an ambulatory aid having a set of ferrules in accordance with an illustrative embodiment:

FIG. 2 is an illustration of a ferrule in accordance with an illustrative embodiment;

FIG. 3 is illustration of another view of an improved ferrule in accordance with an illustrative embodiment;

FIG. 4 is an illustration of a cross-sectional view of the ferrule in accordance with an illustrative embodiment;

FIG. 5 is an illustration of a cross-sectional view of the ferrule in a neutral state in accordance with an illustrative embodiment;

FIG. 6 is an illustration of a cross-sectional view of the ferrule in a retracted state in accordance with an illustrative embodiment; and

FIG. 7 is a flowchart illustrating a process for operating a walker having a set of ferrules in accordance with an illustrative embodiment.

### DETAILED DESCRIPTION

The different illustrative embodiments disclosed herein recognize that many people may require the use of an ambulatory aid. Ambulatory aids may take any shape or size and refer to any type of currently existing or later developed device for assisting users to stand and/or walk. Examples of ambulatory aids include, but are not limited to walkers and canes. A cane a device having a handle connected to a shaft that terminates at one or more ferrules. Ferrules are generally formed from an elastomeric material, such as rubber or a hard plastic. A traditional cane may terminate at a single ferrule. In other configurations, when additional support and stability is required, the cane may terminate in three or more ferrules.

A walker is another type of ambulatory aid that has a frame formed from two substantially parallel side elements, each of which has a front leg and a rear leg, thus, defining a pair of front legs and a pair of rear legs. The four legs contact the floor surface generally in the shape of a rectangle. Each side frame element includes a handgrip located on an upper portion of the frame and is substantially parallel to the floor surface. A user's hands contact the handgrip to enable the user to move the walker forward, and to provide support and/or balance while the user steps toward the frame.

Walkers can be configured with a number of different terminal accessories. A terminal accessory is a component that is attached to the end of the walker leg and serves as the interface between the walker and the floor surface. Terminal accessories are often removable. Non-limiting examples of terminal accessories include females, wheels, and sometimes even modified tennis balls. Terminal accessories are sometimes chosen based upon a particular user's physical limitations and other requirements. For example, configurations of terminal accessories may be selected based upon a user's strength and/or level of mobility. In one configuration, the walker is outfitted with one ferrule on each of the four legs. In another configuration, each leg of the walker is attached to a wheel. In yet another common configuration, the walker is outfitted with one wheel on each of the front legs, and one ferrule (or tennis ball) on each of the rear legs.

One of the most common configurations of terminal accessories for walkers includes one wheel on each of the front legs and one rubber ferrule on each of the rear legs. The wheels enable the user to push the walker forward without having to lift the entire walker. This factor may be crucial for users who may lack sufficient upper body strength to lift the walker. The rubber ferrules on the rear legs provide stability for the user, especially if the user frequently leans on the walker for support. When the walker is stationary, the rubber ferrules frictionally engage the floor surface and prevent the walker from sliding around and compromising the user's balance and steadfastness. One disadvantage is that the walker bounces as the rubber ferrules frictionally engage and disengage the floor surface as the walker is being slid across the floor surface. This bouncing effect may be uncomfortable and potentially dangerous for the user as vibrations are transmitted up the user's arms.

To remedy the undesirable effects caused by the use of rubber ferrules, some users have affixed tennis balls over the rubber ferrules. The felt surface of the tennis ball allows the walker legs to glide over various floor surfaces, which eliminates the bouncing effect of the rubber ferrules. One drawback is that the walker loses the ability to frictionally engage the floor surface thereby decreasing the overall stability offered to a user. For example, if the user attempts to put weight on the walker, such as in the instance where a user may use the walker to regain balance or prevent a fall, placing weight on the handgrips in any direction other than straight down could cause the walker to drift in the direction of the force. The unintended drifting of the walker could cause the user to lose balance and potentially suffer a dangerous fall. The same effect can be observed if the rubber ferrules were replaced with hard plastic ferrules, or another pair of wheels, or even if all four legs were fitted with hard plastic ferrules.

The greatest stability can be achieved when each of the walker legs is fitted with a rubber ferrule. However, this configuration requires the user to possess sufficient strength to be able to lift the walker to advance the walker to permit forward movement. Many users, particularly the elderly, would find this task difficult, if not impossible.

In light of the foregoing, the different illustrative embodiments disclosed herein recognize that currently existing configurations of terminal accessories affixed to walker legs sacrifice support and stability for improved mobility, or alternatively, sacrifice mobility for increased stability and support. The illustrative embodiments recognize a need for an improved ferrule that enables a user to slide the walker across a floor surface to facilitate a user's movement, but which is also capable of frictionally engaging the floor surface at a user's election to provide added stability. Therefore, the illustrative embodiments provide a ferrule for use with ambulatory aids in general, and a walker in particular, which includes a housing having an aperture at a first end. The aperture is adapted to receive a leg of the ambulatory aid. The ferrule also includes a gliding component having a gliding surface at a second end of the housing. The gliding surface slidably engages a floor surface. Additionally, the ferrule includes a traction component at the second end of the housing. The traction component selectively engages the floor surface with a traction surface in the presence of a compressing force.

Although the figures and descriptions of the illustrative embodiments provided herein depict and describe ferrules utilized with walkers, the term “ambulatory aid” may also refer to other ambulatory aids implementing ferrules, such as canes.

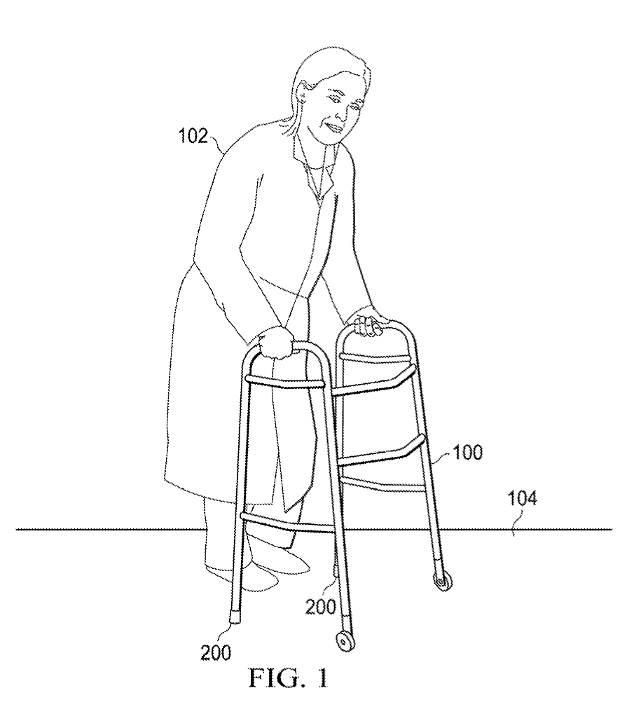

With reference now to the figures, FIG. 1 depicts an ambulatory aid configured with a set of ferrules in accordance with an illustrative embodiment. As used herein, the term “set” may mean one or more. For example, “a set of ferrules” may refer to a single ferrule, or two or more ferrules. In particular, with reference to FIG. 1, the set of ferrules refers to two ferrules, one on each of the rear legs of ambulatory aid 100. More particularly, ambulatory aid 100 is depicted as a walker with a set of ferrules on the rear legs and a set of wheels on each of the front legs. However, in alternate embodiments, the number of ferrules and/or wheels on ambulatory aid 100 may vary provided that ambulatory aid 100 includes at least one ferrule.

Ambulatory aid 100 facilitates the movement of user 102 across floor surface 104. Floor surface 104 is any surface on which user 102 may traverse. Non-limiting examples of floor surface 104 include ramps, bridges, roads, floors, and sidewalks. Additionally, floor surface 104 may be formed from any existing or later developed material. Commonly encountered materials that form floor surface 104 include, but are not limited to tile, concrete, hardwood, marble, carpet, etc.

User 102 operates ambulatory aid 100 by manipulating the frame of ambulatory aid 100. For example, user 102 may grasp the handgrips located at the upper, parallel portions of ambulatory aid 100 to assist in walking or standing. When ambulatory aid 100 is used to maintain balance and serve as a tool to prevent a fall, little weight, if any, is exerted on ambulatory aid 100 by user 102. For example, user 102 may slide ambulatory aid 100 in front as user 102 walks between or slightly behind the side frame elements of ambulatory aid 100. In contrast, when using ambulatory aid 100 to help support the weight of user 102, user 102 may move ambulatory aid 100 forward slightly and then lean on the handgrips of ambulatory aid 100 as user 102 steps into the area between the side frame elements. In this manner, user 102 is able to use some upper body strength to help reduce the burden and/or exertion on the legs, hips, and joints of user 102. Repeating this action enables user 102 to traverse floor surface 104.

As previously discussed, currently available ferrules either provide traction and thus retard the sliding motion of an ambulatory aid, or are configured to slide easily but lack the ability to provide much traction. In contrast to currently available ferrules, ferrule 200 is configured to allow a user to slide an attached ambulatory aid across a floor surface, but also to frictionally engage the floor surface, at the user's election, when additional stability is needed. Furthermore, a user is not required to add, remove, or replace the ferrule or pieces thereof. Ferrule 200 provides this functionality by implementing a retractable gliding component that facilitates gliding when ferrule 200 is in a neutral state, and retards gliding (reduces undesirable movement and promotes stability) when ferrule 200 is in a retracted state.

Referring to ferrule 200 in one of two end states facilitates a description of the construction and operation of ferrule 200. To this end, ferrule 200 can be considered to be in a neutral state when a traction surface of ferrule 200 is disengaged from floor surface 104. When the traction surface is disengaged from floor surface 104, ferrule 200 can slide around floor surface 104 on a gliding surface of ferrule 200. Ferrule 200 is in a neutral state in the absence of a compressing force.

Ferrule 200 is in a retracted state when a traction surface of ferrule 200 is engaged with floor surface 104. The gliding surface of ferrule 200 may or may not also be in contact with floor surface 104 when the traction surface is in contact with floor surface 104. Ferrule 200 is in a retracted state in the presence of a compressing force. User 102 can generate the compressing force sufficient to cause the gliding component to retract into a cavity of ferrule 200 and engage floor surface 104 with the traction surface of ferrule 200. In most instances, this compressing force is generated by user 102 as user 102 leans on handgrips of ambulatory aid 100, thereby transmitting a component of force down the legs of ambulatory aid 100 and serve as a compressing force for ferrule 200.

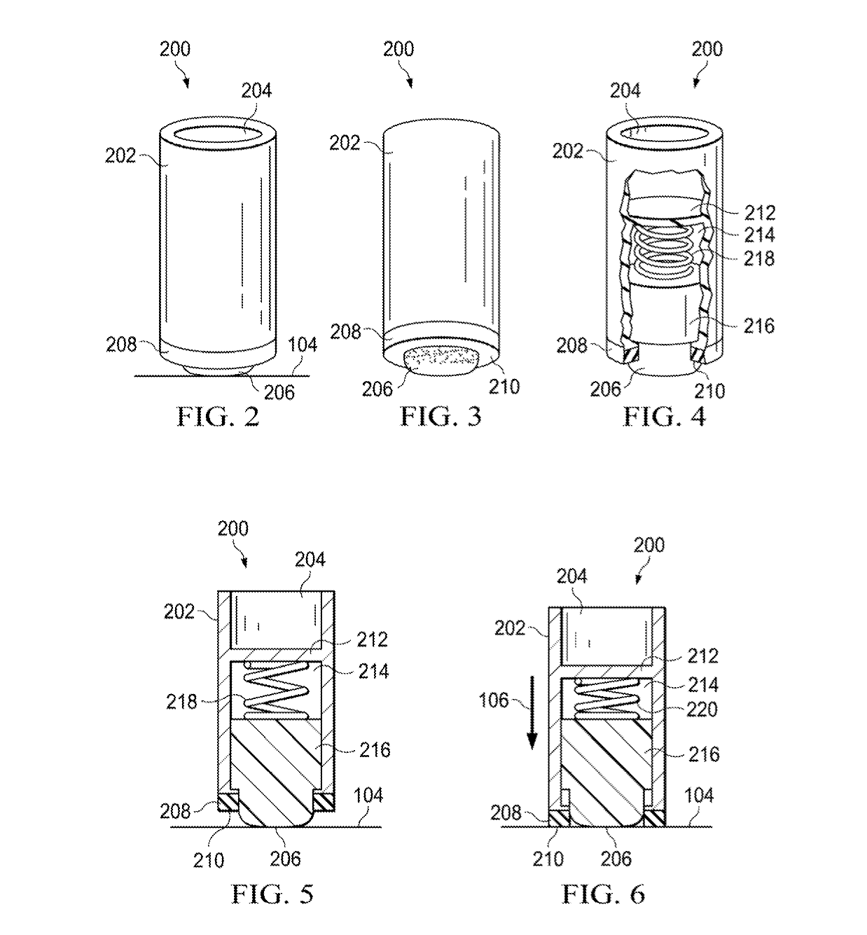

FIGS. 2 and 3 depict different views of ferrule 200 in accordance with an illustrative embodiment. Housing 202 forms the body of ferrule 200. The upper portion of housing 202 includes aperture 204 adapted to receive a leg of ambulatory aid 100. Housing 202 also includes a cavity (shown in FIGS. 4-6) which substantially encloses a gliding component of ferrule 200 when ferrule 200 is in a neutral state. The gliding component includes gliding surface 206 which may be exposed at the lower portion of housing 202, opposite to aperture 204. Gliding surface 206 is a surface of a gliding component which slidably engages floor surface 104.

In the illustrative embodiment of FIGS. 2 and 3, traction component 208 is coupled to the lower end of housing 202. Traction component 208 is a member of ferrule 200 that is located at the lower end of ferrule 200, opposite aperture 204, and is formed from a material having elastomeric properties, including, but not limited to, rubber. Elastomeric materials maintain their shape and are capable of frictionally engaging floor surface 104. In particular, traction component 208 selectively engages floor surface 104 with traction surface 210. Traction surface 210 is an area of traction component 210 which is substantially parallel to floor surface 104 and capable of selectively engaging floor surface 104 when ferrule 200 is in a retracted state. Traction surface 210 selectively engages floor surface 104 because traction surface 210 only contacts floor surface 104 when user 102 generates the force to cause a gliding component to retract into a cavity of ferrule 200.

Gliding surface 206 may be formed from a hard plastic, felt, or any other material having a coefficient of friction less than a coefficient of friction of traction surface 210 of traction component 208. Other components of ferrule 200, such as housing 202 may be constructed from any currently existing or later developed material. Preferably, those other components of ferrule 200 are constructed from strong, lightweight materials, such as plastics, certain metals (such as aluminum), polymers (such as carbon fiber), and/or alloys.

With reference to FIGS. 2 and 3, in an illustrative embodiment, a leg of ambulatory aid 100 is inserted into aperture 204 and at least a portion of the end of the leg is encompassed by housing 202. Because traction surface 210 is disengaged from floor surface 104 in FIGS. 2 and 3, ferrule 200 is depicted in a neutral state. In a neutral state ferrule 200 is able to slide across floor surface 104 on gliding surface 206. In the presence of a compressing force, gliding surface 206 retracts sufficiently into a cavity of housing 202 to enable traction surface 210 to frictionally engage floor surface 104. Contact between floor surface 104 and traction surface 210 provides user 102 more stability and retards the sliding of ferrule 200 across floor surface 104.

FIG. 4 is a cross-sectional view of ferrule 200 in accordance with an illustrative embodiment. The cross-sectional view depicts an exemplary internal configuration of ferrule 200. As can be seen, the depth of aperture 204 is established by divider 212. Divider 212 is a separator that both supports a leg of ambulatory aid 100 inserted into aperture 204, and also separates aperture 204 from cavity 214.

Cavity 214 is a compartment within housing 202 that is dimensioned to accommodate gliding component 216 when ferrule 200 is in a retracted state. Gliding component 216 is a retractable member of ferrule 200 capable of extending, at least partially, outside of cavity 214, as well as withdrawing entirely into cavity 214. Gliding component 216 includes gliding surface 206. In a neutral state, gliding surface 206 is the portion of gliding component 216 that is exposed at the lower end of housing 202 and in contact with floor surface 104.

Gliding surface 206 may be formed of the same material as gliding component 216 or from a different material entirely. For example, gliding surface 206 may be formed from the same hard plastic that forms gliding component 216. In another non-limiting embodiment, gliding component 216 may be formed from a hard plastic, but gliding surface 206 may be formed from a felt material, such as, but without limitation, a tennis ball.

Spring component 218 is also located within cavity 214. Spring component 218 is a device capable of exposing gliding surface 206 outside of cavity 214 when ferrule 200 is in a neutral state. In addition, spring component 218 is capable of ejecting, at least partially, gliding component 216 from cavity 214 to change ferrule 200 from a retracted state to a neutral state. In particular, spring component 218 is adapted to eject gliding component 216 sufficient to expose gliding surface 206 from cavity 214. In this illustrative example in FIG. 4, spring component 218 is a simple compression spring capable of storing potential energy when a compressing force compresses spring component 218 between gliding component 216 and divider 212 to form compressed spring component 220. The energy stored in compressed spring component 220 provides the force necessary to eject gliding component 216, at least partially, from cavity 214 when the compressing force is released.

In the embodiment where spring component 218 is a simple compression spring, different spring constants for spring component 218 may be selected for use in ferrule 200 depending upon a number of different factors. For example, a spring constant should be selected so that the weight of ambulatory aid 100 would not be sufficient, on its own, to compress spring component 218 to engage floor surface 104 with traction surface 210. The compressing force sufficient to engage floor surface 104 with traction surface 210 should be generated by user 102.

Another factor for consideration in selecting a spring constant for spring component 218 is a weight of user 102. For example, a spring constant that is selected for a heavier user may not be appropriate for a lightweight user who could not generate a sufficient compressing force to engage floor surface 104 with traction surface 210. Likewise, a spring constant appropriate for a lightweight user may enable ferrule 200 to achieve an unintended retracted state when being operated by a larger, heavier user.

In the illustrative example in FIG. 4, spring component is depicted as a simple compression spring. However, in alternate embodiments, spring component 218 may be any type of device or set of devices working in conjunction to eject, at least partially, gliding component 216 from within cavity 214. For example, spring component 218 may be piston or airtight bladder that stores potential energy when exposed to a compressing force. In addition, spring component 218 may also take the form of rubber bands or tension springs capable of storing potential energy in the presence of a compressing force that elongates the spring component. Release of the compressing force would allow the rubber band or tension spring to contract and eject gliding component 216.

FIG. 5 is a cross-sectional view depicting ferrule 200 in a neutral state in accordance with an illustrative embodiment. Although not shown in this figure, a leg of ambulatory aid 100 may be inserted into aperture 204 and supported by divider 212. An exemplary configuration is depicted in FIG. 1.

In FIG. 5, spring component 214 contacts divider 212 and gliding component 216 and, when ferrule 200 is in a neutral state, spring component 214 provides the tension necessary to maintain gliding surface 206 outside of cavity 214 and in contact with floor surface 104. In this neutral state, traction surface 210 of traction component 208 is disengaged from floor surface 104. When gliding surface 206 is in contact with floor surface 104, a leg of ambulatory aid 100 is able to slide more easily across floor surface 104 by virtue of its attachment to ferrule 200.

FIG. 6 is a cross-sectional view depicting ferrule 200 in a compressed state in accordance with an illustrative embodiment. Although not shown in this figure, a leg of ambulatory aid 100 may be inserted into aperture 204 and supported by divider 212. An exemplary configuration is depicted in FIG. 1.

Compressing force 106 is a force generated by user 102 sufficient to compress spring component 218 to form compressed spring component 220 and allow gliding component 216 to retract gliding component 216 into cavity 214. When gliding component 216 is retracted into cavity 214, traction surface 210 is able to engage floor surface 104.

Compressing force 106 is generated by user 102. In a non-limiting example, compressing force 106 is generated when user 102 leans on handgrips of ambulatory aid 100, transmitting a component of downward force down the frame of ambulatory aid 100 to ferrule 200. When compressing force 106 is released, compressed spring component 220 expands to reform spring component 218 and eject at least a portion of gliding component 216. In particular, the expansion of compressed spring component 220 ejects gliding surface 206 from cavity 214, which disengages traction surface 210 from floor surface 104. In this illustrative example, compressing force 106 is released when user 102 ceases leaning on ambulatory aid 100.

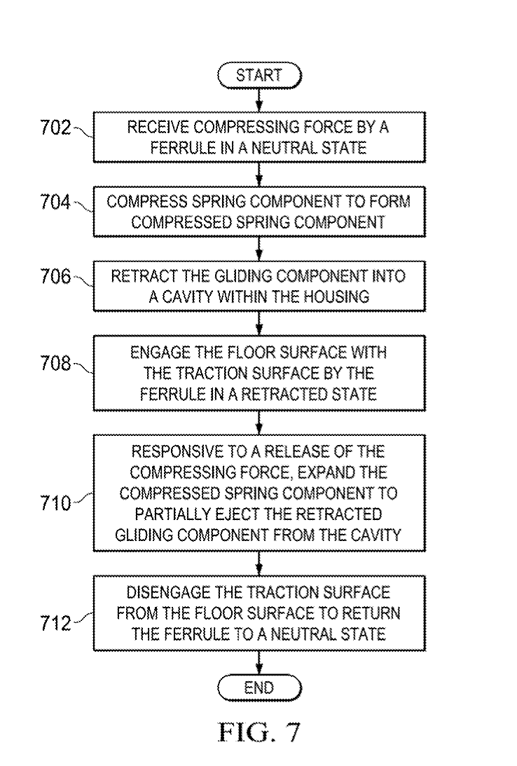

FIG. 7 is a flowchart illustrating steps describing the use of a ferrule coupled to an ambulatory aid in accordance with an illustrative embodiment. The process in FIG. 7 may be implemented by a user operating an ambulatory aid having a set of ferrules, such as ferrule 200 in FIG. 1.

The process begins by receiving a compressing force at a ferrule in a neutral state (step 702). The compressing force may be generated by user 102 when user 102 leans on a frame element of ambulatory aid 100, such as the handgrips, and transmits a component of downward force through ambulatory aid 100 to the set of ferrules. The compressing force compresses a spring component to form a compressed spring component (step 704). The compressing force also causes the gliding component to retract into a cavity within the housing (step 706). The retracted gliding component enables the traction surface to engage the floor surface and enables the ferrule to assume a retracted state (step 708). The traction surface frictionally engages the floor surface, which provides additional traction and stability to the user.

In response to a release of the compressing force, the compressed spring component is expanded to reform the spring component and partially eject the gliding component from the cavity within the housing (step 710). The traction surface is disengaged from the floor surface (step 712) and the process terminates.

The illustrative embodiments provide an improved ferrule for use with an ambulatory aid, such as a walker. The improved ferrule presents a user with the benefits of having an ambulatory aid capable of gliding easily across a variety of floor surfaces, yet still permits the user to selectively engage the floor surface with a traction surface. When the floor surface is in contact with the traction surface, the ambulatory aid achieves additional traction and stability. In addition, the illustrative embodiments disclosed herein recognize that the compressing force is generated during the natural and intended use of the ambulatory aid, at a time when additional stability would be beneficial. In particular, the loss of traction may be particularly dangerous during times when the user is leaning on the ambulatory aid for support. The loss of traction when a user is leaning on the ambulatory aid for support may cause the ambulatory aid to shift, and may cause users to lose balance and possibly suffer injury in a fall.

The improved ferrule described herein may also be used on other types of ambulatory aids, such as a quad-cane. The heavier base may make lifting the quad-cane difficult. As such, a quad-cane outfitted with the improved ferrules disclosed herein may enable the user to easily slide the cane along the floor surface, yet still have the cane frictionally engage the floor surface as needed.

The flowchart and block diagrams in the figures illustrate the architecture, functionality, and operation of possible implementations of methods, apparatus, and systems according to various illustrative embodiments. In this regard, each block in the flowchart or block diagrams may represent a step or instructions for implementing an embodiment(s). It should also be noted that, in some alternative implementations, the steps may occur out of the order noted in the figures. For example, two steps shown in succession may, in fact, be executed substantially concurrently, or the steps may sometimes be executed in the reverse order, depending upon the functionality involved.

The foregoing detailed description illustrates exemplary embodiments for purposes of illustration, and to provide a thorough understanding of the invention. However, it will be apparent to one skilled in the art that modifications can be made to certain details of the improved ferrule without detracting or deviating from its intended use as disclosed herein. In fact, many modifications and variations are possible in view of the above teachings. For example, the housing of the improved ferrule is depicted as having a cylindrical shape; however, those of ordinary skill in the art recognize that modifications to the shape of the housing can be made without deviating from the intended use of the improved ferrule. In addition, the gliding surface of the improved ferrule is shown to have an outwardly arcuate (convex) shape. The arcuate shape may be preferable because there is a decreased chance of it snagging on carpets, door jambs, uneven pavement, or other uneven floor surfaces as the walker is slid across a floor surface. However, the shape of the gliding surface can be modified without detracting or deviating from the intended use of the ferrule disclosed herein. Thus, the foregoing descriptions of specific embodiments of the present invention are provided for purposes of illustration and description. The specific embodiments disclosed are not intended to be exhaustive or to limit the invention to the precise forms disclosed. The embodiments were chosen and described in order to best explain the principles of the invention and its practical applications and to thereby enable others skilled in the art to best utilize the invention and various embodiments with various modifications as are suited to the particular use contemplated.

What is claimed is:

1. A ferrule comprising:
a housing having an aperture at a first end, wherein the aperture is adapted to receive a leg of an ambulatory aid;
a gliding component comprising a gliding surface at a second end of the housing, wherein the gliding surface slidably engages a floor surface; and
a traction component at the second end of the housing, wherein the traction component selectively engages the floor surface with a traction surface of the traction component.

2. The ferrule of claim 1, further comprising:
a cavity within the housing, wherein the cavity is dimensioned to accommodate the gliding component when the ferrule is in a retracted state.

3. The ferrule of claim 1, further comprising:
a spring component for ejecting the gliding component from a cavity sufficient to expose the gliding surface from the cavity.

4. The ferrule of claim 3, wherein the spring component is located within the cavity, and wherein a first end of the spring component is coupled to the gliding component and a second end of the spring component is coupled to a divider separating the cavity from the aperture.

5. The ferrule of claim 3, wherein the spring component compresses between the gliding component and the divider in response to a compressing force to form a compressed spring component, and wherein the gliding component retracts into the cavity of the housing in response to the compressing force.

6. The ferrule of claim 5, wherein the traction surface engages the floor surface when the gliding component retracts into the cavity of the housing and the ferrule is in a retracted state.

7. The ferrule of claim 5, wherein the compressing force is generated by a user exerting a downward force on the ambulatory aid, and wherein the compressing force is transmitted down a leg of the ambulatory aid to the ferrule.

8. The ferrule of claim 1, wherein the gliding surface further comprises an outwardly arcuate shaped surface for contacting the floor surface, and wherein the gliding surface has a lower coefficient of friction than the traction surface.

9. The ferrule of claim 1, wherein the traction component comprises an elastomeric material.

10. An ambulatory aid comprising a set of ferrules, and wherein each ferrule in the set of ferrules further comprises:
a housing having an aperture at a first end, and wherein the aperture is adapted to accept a leg of the ambulatory aid; a gliding component comprising a gliding surface at a second end of the housing, wherein the gliding surface slidably engages a floor surface; and a traction component at the second end of the housing, wherein the traction component selectively engages the floor surface with a traction surface of the traction component.

11. The ambulatory aid of claim 10, wherein each ferrule in the set of ferrules further comprises:
a cavity within the housing, wherein the cavity is dimensioned to accommodate the gliding component when a ferrule from the set of ferrules is in a retracted state.

12. The ambulatory aid of claim 10, wherein each ferrule in the set of ferrules further comprises:
a spring component for ejecting the gliding component from the cavity sufficient to expose the gliding surface from the cavity.

13. The ambulatory aid of claim 12, wherein the spring component is located within the cavity, and wherein a first end of the spring component is coupled to the gliding component and a second end of the spring component is coupled to a divider separating the cavity from the aperture.

14. The ambulatory aid of claim 10, wherein the gliding surface further comprises an outwardly arcuate shaped surface for contacting the floor surface, and wherein the gliding surface has a lower coefficient of friction than the traction surface.

15. The ambulatory aid of claim 10, wherein the traction component is formed from an elastomeric material.

16. A method for using a ferule coupled to a leg of an ambulatory aid, the method comprising:
responsive to receiving a compressing force by a ferrule in a neutral state, retracting a gliding component into a cavity within a housing of the ferrule; and
engaging, by the ferrule in a retracted state, a floor surface with a traction surface of a traction component of the ferrule.

17. The method of claim 16, wherein retracting the gliding component further comprises:
compressing a spring element in the cavity of the housing to form a compressed spring component.

18. The method of claim 16, further comprising:
responsive to a release of the compressing force, expanding a compressed spring component;
ejecting at least a portion of the gliding component from the cavity of the housing to expose the gliding surface from the cavity; and
disengaging the traction surface from the floor surface to return the ferrule to the neutral state.

19. The method of claim 16, further comprising:
sliding along the floor surface on the gliding surface.

20. The method of claim 16, wherein receiving the compressing force further comprises:
receiving the compressing force from a user leaning on a frame element of the ambulatory aid.
